(19) United States
(12) Patent Application Publication
(10) Pub. No.: US 2016/0353091 A1
(43) Pub. Date: Dec. 1, 2016

(54) DISPLAY DEVICE AND PREPARATION METHOD THEREOF

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Fangjie LI, Beijing (CN); Zhenwei WANG, Beijing (CN); Ying ZHANG, Beijing (CN); Hong ZHU, Beijing (CN); Hongjun YU, Beijing (CN)

(21) Appl. No.: 14/892,776

(22) PCT Filed: May 20, 2015
(86) PCT No.: PCT/CN2015/079332

§ 371 Date: Nov. 20, 2015

(30) Foreign Application Priority Data
Dec. 15, 2014 (CN) 201410779253.3

(51) Int. Cl. H04N 13/04; G02B 1/11; G02B 27/22; G02B 5/32

(52) U.S. Cl. CPC H04N 13/0409; H04N 13/0422; G02B 5/32; G02B 1/11; G02B 27/2214; H04N 2213/001

(57) ABSTRACT

The present invention relates to a display device and a preparation method of a display device. The display device comprises a display panel provided with a plurality of sub-pixels, and a light-splitting unit provided on a light-emitting side of the display panel, the light-splitting unit comprises a substrate having a plurality of grooves provided thereon, a side surface of each groove is a flat surface; and the plurality of grooves and the plurality of sub-pixels are the same in number and respectively correspond to each other in positions . The display device can realize multi-viewpoint glasses-free 3D display; and meanwhile, the display device further has a simple structure and can be easily made small, light and thin.

### FIELD OF THE INVENTION

The present invention belongs to the field of display technology, and specifically relates to a display device and a preparation method thereof.

### BACKGROUND OF THE INVENTION

At present, 3D display technology has become a development tendency in the field of display technology. 3D display technology is generally realized based on the principle of binocular parallax, that is, two parallax images (a left parallax image and a right parallax image, respectively) are displayed on a two-dimensional display screen, and by means of certain technique, the left eye of a viewer can see only the left parallax image on the display screen and the right eye of the viewer can see only the right parallax image on the display screen.

Existing 3D display technologies mainly include polarized 3D display technology, shutter 3D display technology and color splitting 3D display technology. There are some deficiencies in these 3D display technologies, among which, the polarized 3D display technology generally employs a method of dividing space, which results in a loss of resolution, degradations of the 3D display effect, influences on the visual angle, and easily causing crosstalk (i.e. ghosting); the shutter 3D display technology generally employs a method of dividing time, which is likely to cause screen flicker and crosstalk; and the color splitting 3D display technology employs the anaglyphic principle and filters out most of colors, which results in serious distortion of screen colors and severe reduction of brightness, and as a result, the 3D display effect is significantly degraded.

For a display device formed by employing the aforementioned 3D display technologies, it is necessary for a person to wear a pair of glasses adapted thereto when watching the screen. This results in burden to eyes and reduces the comfort during watching. Therefore, 3D display technology without the need to wear a pair of glasses, i.e. glasses-free 3D display technology, emerges at the right moment and has attracted much attention. One technique to realize the glasses-free 3D display is barrier glasses-free 3D display technology using optical grating. Such barrier glasses-free 3D display technology using optical grating has the following defects: the optical grating diffracts light, and the optical grating is unable to orient the light in a certain direction accurately, which will result in divergence of the light on the screen and thus images for the left and right eyes interfere with each other, and as a result, 3D images seen by the two eyes are blurry; and meanwhile, a 3D image realized based on such barrier glasses-free 3D display technology using optical grating has only one viewpoint, which means only one person is allowed to watch in a particular position, otherwise the 3D image would not be seen when there is a little deviation for the eyes. As the barrier glasses-free 3D display technology using optical grating has difficulty in allowing several people to watch at the same time, it fails to obtain commercial application and promotion.

Therefore, a technical problem needed to be solved at present is to design a clear and multi-viewpoint 3D image display device which a person can watch without wearing a pair of glasses.

### SUMMARY OF THE INVENTION

In view of the aforementioned deficiencies in the prior art, a technical problem to be solved by the present invention is to provide a display device and a preparation method thereof. The display device and the display device prepared by the preparation method can realize multi-viewpoint and clear glasses-free 3D display; and meanwhile, the display device has a simple structure and can be easily made small, light and thin.

A technical solution employed to solve the technical problem of the present invention is a display device, including a display panel provided with a plurality of sub-pixels, and a light-splitting unit provided on a light-emitting side of the display panel, wherein the light-splitting unit includes a substrate having a plurality of grooves provided thereon, a side surface of each groove is a flat surface; and the plurality of grooves and the plurality of sub-pixels are the same in number and respectively correspond to each other in positions.

Preferably, the substrate is made of a transparent material; and the grooves are arranged on a surface of the substrate that is an opposite surface with respect to the display panel, and an opening direction of the grooves is away from the display panel.

Preferably, each groove is shaped like a regular N-sided pyramid with an opening of the groove as a bottom, the shape of the bottom of the regular N-sided pyramid is the same as that of the sub-pixel corresponding to the groove, and an apex of each regular N-sided pyramid shaped groove orthographic projects on the display panel in a position of a central point of the sub-pixel corresponding to the groove, where: 3≦N≦8, and N is a positive integer.

Preferably, each of the sub-pixels is shaped like a regular N-sided polygon; and

the sub-pixels having different display colors are arranged in a periodically alternating manner, and a plurality of sub-pixels having different display colors form a pixel of rectangular.

Preferably, the sub-pixels are square; and the grooves are shaped like a right square pyramid, and an apex of each right square pyramid shaped groove is positioned on a centerline of the right square pyramid.

Preferably, thickness of the substrate is greater than height of each groove, the thickness of the substrate is 0.7 to 0.9 times of length of side of the square sub-pixels, and the height of the right square pyramid shaped groove is 0.6 to 0.8 times of the length of side of the square sub-pixels.

Preferably, a holographic dynamic display antireflection film is provided on a side surface of each regular N-sided pyramid shaped groove , and the holographic dynamic display antireflection film is made of non-memory ceramics.

Preferably, the holographic dynamic display antireflection film is made of lead zirconate titanate piezoelectric ceramics.

Preferably, the display panel is a liquid crystal display panel or an organic light-emitting diode display panel.

A preparation method of a display device, including steps of:

forming a display panel provided with a plurality of sub-pixels;

forming a light-splitting unit comprising a substrate having a plurality of grooves provided thereon, a side surface of each groove being a flat surface; and

integrating the display panel and the light-spitting unit, such that the light-spitting unit is positioned on a light-emitting side of the display panel,

wherein, the plurality of grooves and the plurality of sub-pixels are the same in number and respectively correspond to each other in positions.

Preferably, each groove in the light-spitting unit is shaped like a regular N-sided pyramid with an opening of the groove as a bottom; and the sub-pixels in the display panel are shaped like regular N-sided polygon, where: 3≦N≦8, and N is a positive integer.

Preferably, the substrate is made of a transparent material, and the grooves are formed on a surface of the substrate that is an opposite surface with respect to the display panel by forging process.

Preferably, the light-spitting unit is integrated with the display panel by fitting process, so that an opening direction of each groove is away from the display panel, and an apex of each groove orthographic projects on the display panel in a position of a central point of the sub-pixel corresponding to the groove.

Preferably, before integrating the display panel and the light-spitting unit, the method further includes a step of: forming a holographic dynamic display antireflection film on side surfaces of the grooves by coating.

Preferably, the holographic dynamic display antireflection film is made of non-memory ceramics.

The present invention has the following beneficial effects: as a light-spitting unit is additionally provided on the light-emitting side of the display panel in the display device, light emitted from the sub-pixels in the display panel is refracted to various directions by the side surfaces of the regular N-sided pyramid shaped miniature grooves in the light-spitting unit, thereby realizing multi-viewpoint glasses-free 3D display; and the display device further has a simple structure, can be easily made small, light and thin, and thus is convenient to carry.

Accordingly, the above display device can be prepared efficiently and conveniently by applying the preparation method of the display device.

### BRIEF DESCRIPTION OF THE DRAWINGS

FIG. 1 is a side view showing a structure of a display device according to Embodiment 1 of the present invention;

FIG. 2 is a top view of a light-spitting unit as shown in FIG. 1;

FIG. 3 is a perspective view of a partial structure of a display panel and the light-spitting unit as shown in FIG. 1; and

FIG. 4 is a schematic diagram of a light path of the display device according to Embodiment 1 of the present invention.

### REFERENCE NUMERALS IN THE DRAWINGS:

1: display panel;
11: sub-pixel;
2: light-spitting unit;
21: substrate;
22: groove.

### DESCRIPTION OF THE PREFERRED EMBODIMENTS

In order to make those skilled in the art understand the technical solutions of the present invention better, a display device and a preparation method thereof of the present invention will be further described below in detail with reference to the accompanying drawings and specific implementations.

### Embodiment 1

This embodiment provides a display device, which allows a user to watch a clear 3D image without wearing a pair of glasses, and to watch the 3D image from multiple viewpoints.

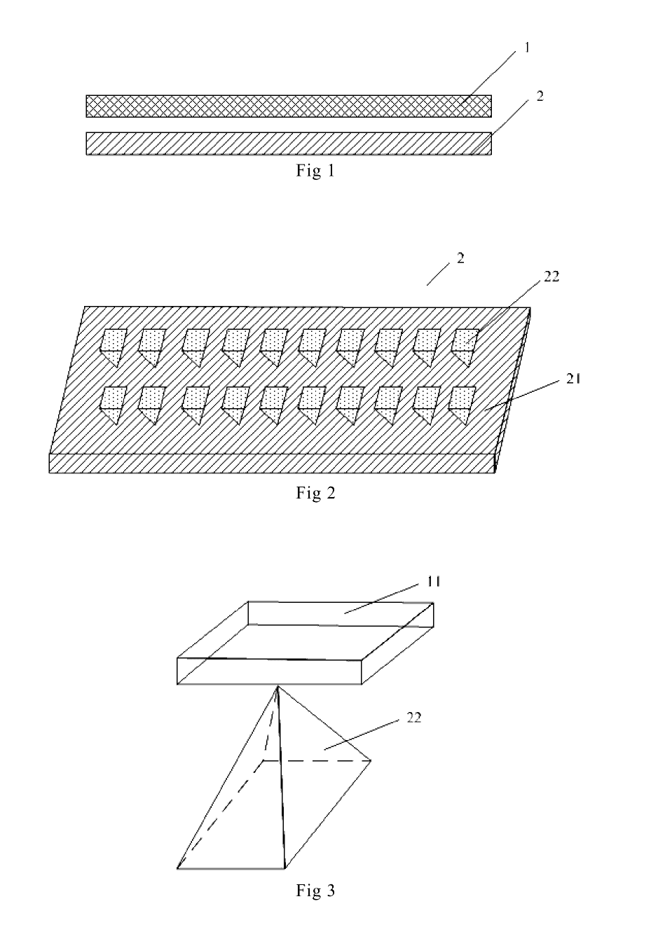

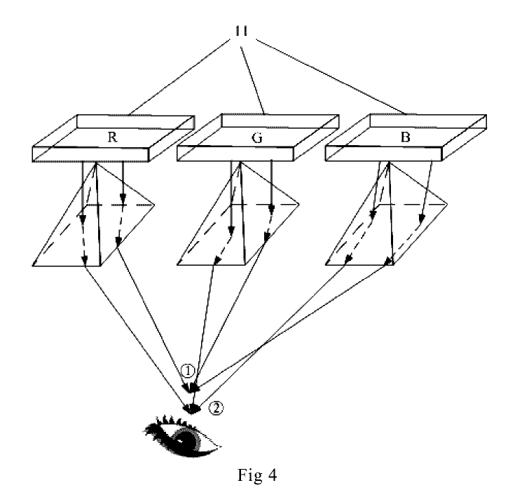

As shown in FIG. 1 to FIG. 3, the display device includes a display panel 1 having a plurality of sub-pixels 11, and a light-splitting unit 2 provided on a light-emitting side of the display panel 1. The light-splitting unit 2 includes a substrate 21 having a plurality of grooves 22 provided thereon, each of the grooves 22 may have a plurality of flat side surfaces, and the grooves 22 and the sub-pixels 11 are the same in number and respectively correspond to each other in positions . The groove 22 can disperse light, emitted from a corresponding sub-pixel 11, transmitted through the substrate 21 and then incident onto the groove 22, to the plurality of side surfaces of the groove 22. The light, irradiated from different sub-pixels contained in one pixel onto the same side surfaces of corresponding grooves 22, converges to form separate images of the pixel on one side, away from the display panel 1, of the light-spitting unit 2, after being refracted. The separate images, respectively formed by light converging after reflected by each side surface, are superposed in eyes to form a 3D image. In the above description, the same surface sides refer to side surfaces facing the same direction. Taking a case that each groove has four side surfaces as an example, it is assumed that the four side surfaces face east, west, south and north respectively, and then side surfaces of different grooves facing east are the same side surfaces, and so forth.

The substrate 21 may be made of transparent material, the grooves 22 are arranged on a surface, away from the display panel 1, of the substrate 21, and an opening direction of the grooves 22 is away from the display panel 1. Specially, each groove 22 is shaped like a regular N-sided pyramid having the opening of the groove as a bottom; the opening of each groove 22 shaped like a regular N-sided pyramid corresponds in position to a corresponding sub-pixel 11, and has the same shape as the corresponding sub-pixel 11; and an orthographic projection of an apex of each groove 22 shaped like a regular N-sided pyramid on the display panel 1 is positioned at a central point of the sub-pixel 11 corresponding to the groove 22, where: 3≦N≦8, and N is a positive integer.

Simply speaking, the light-spitting unit 2, provided with grooves 22 which are in one-to-one correspondence with the sub-pixels 11, used for spitting light and shaped like a regular N-sided pyramid, is made of a transparent thin glass plate or a plastic plate (Compared to the glass plate, the plastic plate can be made thinner). Each sub-pixel 11 corresponds to a miniature groove 22 shaped like a regular N-sided pyramid. Herein, the groove 22 is “miniature”, because the groove 22 has a miniature structure corresponding to the size of the sub-pixel 11, typically a μm-level structure (generally, the size of the groove 22 shaped like a regular N-sided pyramid in a small-sized display device such as a mobile phone or the like is just more than ten microns, and the size of the groove 22 shaped like a regular N-sided pyramid in a large-sized display device such as a television or the like is hundreds of microns). Each sub-pixel 11 corresponds to a miniature groove 22 shaped like a regular N-sided pyramid. As the groove 22 shaped like a regular N-sided pyramid has a tip of the regular N-sided pyramid (that is, the tip of the groove 22 shaped like a regular N-sided pyramid is not truncated to form a regular N-sided frustum), it can be ensured that all effective light emitted from each sub-pixel 11 can be incident onto each side surface of the grooves 22 shaped like a regular N-sided pyramid, thus to ensure full use of all the effective light emitted from the sub-pixels 11. Therefore, the loss of light may be minimized to the maximum extent and the brightness of the display device can be ensured.

It should be understood herein that N side surfaces in each groove 22 shaped like a regular N-sided pyramid have the same shape and same optical properties. Theoretically, the number of the side surfaces of each miniature groove 22 shaped like a regular N-sided pyramid in this embodiment may vary, for example: 3≦N≦8. Within this range, the separate images are clear and less likely to cause ghosting. However, considering the practical production process of display devices at present, the sub-pixels 11 are generally formed into a rectangle in a rectangular display panel 1. Therefore, in this embodiment, the sub-pixels 11 are configured to be a square. Such a configuration has a mature and reliable process and improves the utilization of the display panel 1. Correspondingly, the grooves 22 are configured to be a right square pyramid. In other words, N is preferably 4. When the sub-pixels 11 are configured to have other shapes (such as triangle, pentagon or the like), the arrangement of each layer of wirings in a region corresponding to the sub-pixels 11 should also be considered, in order to realize high utilization of the display panel 1. As separate images in at least two directions are required to be superposed mutually to form a 3D image, in terms of brightness, the smaller N is, the clearer the formed 3D image is, and the higher the brightness of the 3D image is; and the greater N is, the lower the brightness of the formed 3D image is.

In the display device in this embodiment, in order to obtain a better image brightness (to ensure a brightness for normal display at least) and provide an attachment medium (having a function similar to the projection fabric of a projector) for picture displaying, a holographic dynamic display antireflection film is provided on each side surface of each of the grooves 22 shaped like a regular N-sided pyramid. Preferably, the holographic dynamic display antireflection film may be made of non-memory ceramics. For example, the holographic dynamic display antireflection film may be made of lead zirconate titanate piezoelectric ceramics (PZT), and is formed on the side surfaces of the grooves 22 shaped like a regular N-sided pyramid by coating. With a layer of holographic dynamic display antireflection film coated on each side surface of each miniature groove 22 shaped like a regular N-sided pyramid, on one hand, the brightness of the image can be ensured, and on the other hand, the holographic dynamic display antireflection film serves as an image display medium to ensure effective formation of the separate images.

It should be understood herein that the antireflection film made of non-memory ceramics may be replaced by other antireflection films having good performance, such as a common antireflection film (the brightening effect of which is slightly poorer than that of the holographic dynamic display antireflection film), as long as the effective light emitted from the sub-pixels 11 may be used to a large extent. There is no limitation thereto here.

Each sub-pixel 11 is shaped like regular N-sided polygon; the sub-pixels 11 having different display colors are arranged in a periodically alternating manner, and three or four sub-pixels 11 having different display colors form a pixel shaped like a rectangle. For example, three adjacent sub-pixels 11 respectively have different display colors (generally three primary colors of red (R), green (G) and blue (B)), and the three sub-pixels 11 having different display colors form a pixel so as to realize full-color display. Of course, one pixel may also include four adjacent sub-pixels 11 respectively having different display colors (for example, red (R), green (G), blue (B), white (W) and the like).

As an example, the sub-pixels 11 are preferably square. Correspondingly, as shown in FIG. 2, the grooves 22 are shaped like a right square pyramid, and an apex of the grooves 22 shaped like a right square pyramid is positioned on a centerline of the right square pyramid, and four side surfaces of each groove 22 shaped like a right square pyramid play a role of separating the images. That is, the opening of each groove 22 shaped like a right square pyramid is square, and each side surface thereof is shaped like an isosceles triangle. In the display panel 1 in the prior art, the sub-pixels 11 are shaped like a rectangle. In the display device according to this embodiment, the shape of the cross-section of the sub-pixel 11 may be changed from the rectangle to a square on the basis of the arrangement of the sub-pixels of the existing display panel 1, and then a miniature groove 22 shaped like a right square pyramid is formed in a region in the light-spitting unit 2 corresponding to each sub-pixel 11.

In FIG. 2, the apexes of the grooves 22 shaped like a right square pyramid, compared to the openings thereof, are closer to the display panel 1 (that is, the openings of the grooves 22 shaped like a regular N-sided pyramid are far away from the display panel 1, and the apexes of the grooves 22 shaped like a regular N-sided pyramid are close to the display panel 1). Light emitted from the sub-pixels 11 in the display panel 1 is incident onto side surfaces of the grooves 22 shaped like a right square pyramid after transmitted through a solid part of the substrate 21, then refracted by the side surfaces of the grooves 22 shaped like a right square pyramid, and finally emitted from the openings of the grooves 22 shaped like a right square pyramid. By means of a plurality of grooves corresponding to a plurality of sub-pixels contained in one pixel, the refracted light emitted from the openings converges to from separate images of the same number as that of side surfaces of the groove 22 shaped like a right square pyramid (four separate images are formed herein), and the separate images are superposed to form a 3D image that can be viewed from multiple viewpoints.

In order to form good separate images, the grooves 22 are ensured to be shaped like a regular N-sided pyramid, and the thickness of the substrate 21 should be greater than the height of the grooves 22. The thickness of the substrate 21 is preferably 0.7 to 0.9 times of the length of a side of the square sub-pixels 11, and the height of the grooves 22 shaped like a right square pyramid is preferably 0.6 to 0.8 times of the length of a side of the square sub-pixels 11. The size of the opening of such miniature groove 22 shaped like a right square pyramid may be the same as that of the sub-pixel 11, the thickness of the substrate 21 is further preferably 0.8 times of the length of a side of the square sub-pixel 11, and meanwhile, the height of the miniature groove 22 shaped like a right square pyramid is 0.7 times of the length of a side of the square sub-pixel 11.

In the display device in this embodiment, the grooves 22 shaped like a regular N-sided pyramid in the substrate 21 are formed by forging. Miniature grooves 22 shaped like a right square pyramid, corresponding to the sub-pixels 11, are formed by forging a glass plate used as the substrate 21 with precise processing instrument. The smallest thickness of the glass plate cannot be smaller than 0.7 times of the length of a side of the square sub-pixels 11.

The light-spitting unit 2 is integrated with the display panel 1 by fitting process, after the light-spitting unit 2 and the display panel 1 are formed respectively. For example, the light-spitting unit 2 may be directly fitted with the display panel 1 by a fitting process used for fitting a touch screen in the prior art.

The display panel 1 may be a liquid crystal display (LCD) panel or an organic light-emitting diode (OLED) panel. A glasses-free 3D display device is formed by directly fitting the light-spitting unit 2 on the light-emitting side of the display panel 1. According to the invention, there is no need to change the existing production process of the display panel 1, and instead, only the shape of the sub-pixels 11 should be adaptively changed. Therefore, the existing production process can be directly applied to production. Moreover, in addition to the additional cost for preparing the light-spitting unit 2 and for fitting the light-spitting unit 2 and the display panel 1, the production cost of the display panel 1 itself will not be increased. Therefore, the total cost of the formed display device will not be significantly increased as compared with the display device in the prior art.

In this embodiment, the light-spitting effect of the grooves 22 shaped like a right square pyramid on light is as follows: light refracted from the same side surfaces of a plurality of grooves 22 shaped like a right square pyramid converges to form a separate image of a corresponding pixel, and then the separate image is superposed with the separate images formed by convergence of light refracted from the other three side surfaces, to form a 3D image in eyes. That is, it is assumed that there are two grooves 22 shaped like a right square pyramid, four side surfaces of one groove are A1, B1, C1 and D1, four side surfaces of the other groove are A2, B2 , C2 and D2, and the same side surfaces of different grooves are labeled with the same English letter. Light refracted from A1 and A2 converges to form a separate image, light refracted from B1 and B2 converges to form a second separate image, light refracted from C1 and C2 converges to form a third separate image, and light refracted from D1 and D2 converges to form a fourth separate image. Then, the four separate images are incident to eyes from different directions and angles, and superposed to form a 3D image.

In order to explain a light path view of the display device better, the four side surfaces of each miniature groove 22 shaped like a right square pyramid in FIG. 4 may be defined as a side surface A, a side surface B, a side surface C and a side surface D (not specifically shown in FIG. 4 and can be defined randomly). It is assumed that one pixel includes three sub-pixels: a sub-pixel R, a sub-pixel G and a sub-pixel B respectively, and each sub-pixel corresponds to a groove 22 shaped like a right square pyramid. The four side surfaces of each of the three grooves 22 shaped like a right square pyramid corresponding to the three sub-pixels may be regarded as a side surface RA, a side surface RB, a side surface RC and a side surface RD respectively. A light path of any light in the light path view includes three sections, the propagation direction of which is indicated by an arrow. Specifically, the first section is a solid line, which is emitted from the sub-pixels in the display panel 1, transmitted through the transparent glass portion of the substrate 21, and then incident onto the side surfaces of the grooves 22 shaped like a right square pyramid; the second section is a broken line, which is refracted from the side surfaces of the grooves 22 shaped like a right square pyramid and propagates on the side surfaces of the grooves 22 shapes like a right square pyramid; and the third section is a solid line, which is emitted from the openings of the grooves 22 shaped like a right square pyramid.

As shown in FIG. 4, the sub-pixel R, the sub-pixel G and the sub-pixel B are successively adjacent, and so are the three grooves shaped like a right square pyramid corresponding to the three sub-pixels. It is assumed that the side surface A and the side surface C of each groove are arranged opposite to each other, and the side surface B and the side surface D are arranged opposite to each other too. When observed from a front angle of view, in the light path view of the display device, considering light incident to the side surface A of the groove 22 shaped like a right square pyramid corresponding to the sub-pixel 11, of the light emitted from the sub-pixels 11 in the display panel 1, most of the light is refracted by the side surface A and finally emitted from the opening of the groove 22 shaped like a right square pyramid which the side surface A belongs to, thus to reach eyes at each viewpoint. Therefore, light irradiated from each sun-pixel 11 into the side surface A of the corresponding groove 22 shaped like a right square pyramid can reach each viewpoint after the above propagation, and converges at each viewpoint to form a separate image transmitted from the side surface A, and the separate image may be labeled with A′; light entering side surface B, side surface C and side surface D propagates in a similar manner, to form separate images B′, C′ and D′ respectively transmitted from side surface B, side surface C and side surface D at respective viewpoints; and the separate images transmitted from the four different side surfaces are spatially superposed at each viewpoint respectively and thus to reach the eyes at each viewpoint, that is, a 3D image is formed in the eyes. By such analogy, light emitted from the sub-pixels 11 of the display panel 1 can reach the eyes at multiple viewpoint, and hence, so a 3D image displayed on the display panel 1 may be seen from various directions, so that the display device has multiple angles of view, and meanwhile, a wide angle of view can be ensured. In the sub-pixel R, the sub-pixel G and the sub-pixel B in one pixel, the side surface RA, the side surface RB, the side surface RC, the side surface RD and the like follow the aforementioned rule of imaging, in order to form a full-color 3D image. It should be understood herein that FIG. 4 just shows light paths for forming two groups of separate images. For ease of illustration, the viewpoints \textcircled{1} and \textcircled{2} in FIG. 4 are slightly staggered, but actually they are in the same position. Meanwhile, in the present invention, “transmission” means that light propagates in the same medium, and “refraction” and “reflection” both occur at a junction of two different media. The display process of the display device in this embodiment is as follows:

after the display device is powered on (the liquid crystal display panel is powered on or the organic light-emitting diode emits light), light emitted from each sub-pixel 11 on the display panel 1 may be incident onto the side surfaces of the miniature groove 22 shaped like a regular N-sided pyramid corresponding to the sub-pixel 11, and may be refracted to various directions by the side surfaces. When the eyes see the displayed images in front of the display panel 1, most of light emitted from the corresponding sub-pixels in various directions and reflected by the same side surfaces of the miniature grooves 22 shaped like a regular N-sided pyramid can enter the eyes to form the image displayed on the display panel 1. Similarly, the other N−1 side surfaces can also form displayed images in the eyes, and the displayed images formed in the eyes by means of the N side surfaces are superposed to provide a three-dimensional sense to the eyes. That is, a 3D image can be seen with naked eyes. As each side surface can refract light emitted from the corresponding sub-pixel to various directions, the display device may have multiple angles of view, so that many people are allowed to see the 3D images (including animated video) with naked eyes at the same time. In the display device in this embodiment, a light-spitting unit is additionally provided on the light-emitting side of the display panel. Light emitted from the corresponding sub-pixels in the display panel is refracted to various directions by means of the side surfaces of the miniature grooves shaped like a regular N-sided pyramid in the light-spitting unit, thereby realizing multi-viewpoint glasses-free 3D display, which conforms to people's normal viewing habits; and meanwhile, by adding an antireflection film onto the side surfaces of the miniature grooves shaped like a regular N-sided pyramid, the brightness of the displayed image is ensured. Additionally, the display device further has a simple structure and can be easily made small, light and thin, and is convenient to carry and is especially applicable to mobile display devices such as a mobile phone, a computer, a vehicle display or the like.

### Embodiment 2

This embodiment provides a preparation method of a display device, which is applicable to prepare the display device provided in Embodiment 1.

A preparation method of a display device is provided, including the following steps S1) to S3).

At step S1), a display panel provided with a plurality of sub-pixels is formed.

In this step, each sub-pixel is shaped like a regular N-sided polygon, where: 3≦N≦8, and N is a positive integer; and the sub-pixels having different display colors are arranged in a periodically alternating manner, and three or four sub-pixels having different display colors form one pixel in a shape of a rectangle.

Here, the display panel may be a liquid crystal display (LCD) panel or an organic light-emitting diode (OLED) panel. For preparing the display panel, a method for preparing a panel of a corresponding type in the prior art may be used, which will not be described in detail here.

At step S2), a light-splitting unit including a substrate having a plurality of grooves provided thereon is formed, a side surface of each groove being a flat surface.

In this step, the substrate is made of a transparent material, the number of grooves is the same as that of the sub-pixels, the grooves are shaped like a regular N-sided pyramid, the shape of the opening of each groove shaped like a regular N-sided pyramid is the same as that of the sub-pixel, and the grooves are formed on a side surface of the substrate by forging process. The forging process is used to form the light-spitting unit, which can effectively ensure the fitting accuracy between the grooves in the light-spitting unit and the sub-pixels in the display panel, as well as a high yield rate of the grooves.

In order to obtain a better screen brightness (at least to ensure the brightness of normal display) and provide an attachment medium (having a function similar to the projection fabric of a projector) for image display, this step further includes: forming a holographic dynamic display antireflection film on flat side surfaces of the grooves by coating. Preferably, the holographic dynamic display antireflection film is made of non-memory ceramics, for example, lead zirconate titanate piezoelectric ceramics.

Further preferably, the sub-pixels are square, the grooves are shaped like a right square pyramid, and an apex of each groove shaped like a right square pyramid is positioned on a centerline of the right square pyramid.

It should be understood herein that there is no limitation to the order of forming the display panel in step S1) and forming the light-spitting unit in step S2), and in the practical preparation process, the production may be flexibly scheduled according to equipment conditions or process conditions.

At step S3), the display panel and the light-spitting unit are integrated, such that the light-spitting unit is positioned on a light-emitting side of the display panel, and the grooves are in one-to-one correspondence in position with the sub-pixels.

In this step, the light-spitting unit is integrated with the display panel by fitting process, and for example, the light-spitting unit may be directly fitted with the display panel by a fitting process used for fitting a touch screen in the prior art. Here, the opening direction of the grooves is away from the display panel, and an orthographic projection of an apex of each groove on the display panel is positioned at a central point of the sub-pixel corresponding to the groove.

The display device in the Embodiment 1 can be prepared efficiently and conveniently by applying the preparation method of a display device of this embodiment.

It should be understood that the aforementioned implementations are exemplary implementations merely used for describing the principle of the present invention, and the present invention is not limited thereto. For a person of ordinary skill in the art, various variations and improvements may be made without departing from the spirit and essence of the present invention, and these variations and improvements should be regarded as falling into the protection scope of the present invention.

1. A display device comprising a display panel provided with a plurality of sub-pixels, wherein the display device further comprises a light-splitting unit provided on a light-emitting side of the display panel, the light-splitting unit comprises a substrate having a plurality of grooves provided thereon, a side surface of each groove is a flat surface, and the plurality of grooves and the plurality of sub-pixels are the same in number and respectively correspond to each other in positions.

2. The display device according to claim 1, wherein the substrate is made of a transparent material; and the grooves are arranged on a surface of the substrate that is an opposite surface with respect to the display panel, and an opening direction of the grooves is away from the display panel.

3. The display device according to claim 2, wherein each groove is shaped like a regular N-sided pyramid with an opening of the groove as a bottom, the shape of the bottom of the regular N-sided pyramid is the same as that of the sub-pixel corresponding to the groove, and an apex of each regular N-sided pyramid shaped groove orthographic projects on the display panel in a position of a central point of the sub-pixel corresponding to the groove, where: 3≦N≦8, and N is a positive integer.

4. The display device according to claim 3, wherein each of the sub-pixels is shaped like a regular N-sided polygon; and
the sub-pixels having different display colors are arranged in a periodically alternating manner, and a plurality of sub-pixels having different display colors form a pixel i of rectangular.

5. The display device according to claim 3, wherein the sub-pixels are square; and the grooves are shaped like a right square pyramid, and an apex of each right square pyramid shaped groove is positioned on a centerline of the right square pyramid.

6. The display device according to claim 5, wherein thickness of the substrate is greater than height of each groove, the thickness of the substrate is 0.7 to 0.9 times of length of side of the square sub-pixels, and the height of the right square pyramid shaped grooves is 0.6 to 0.8 times of the length of side of the square sub-pixels.

7. The display device according to claim 3, wherein a holographic dynamic display antireflection film is provided on a side surface of each regular N-sided pyramid shaped groove, and the holographic dynamic display antireflection film is made of non-memory ceramics.

8. The display device according to claim 7, wherein the holographic dynamic display antireflection film is made of lead zirconate titanate piezoelectric ceramics.

9. The display device according to claim 1, wherein the display panel is a liquid crystal display panel or an organic light-emitting diode display panel.

10. A preparation method of a display device, comprising steps of:
forming a display panel provided with a plurality of sub-pixels;
forming a light-splitting unit comprising a substrate having a plurality of grooves provided thereon, a side surface of each groove being a flat surface; and
integrating the display panel and the light-spitting unit, such that the light-spitting unit is positioned on a light-emitting side of the display panel, wherein, the plurality of grooves and the plurality of sub-pixels are the same in number and respectively correspond to each other in positions.

11. The preparation method of a display device according to claim 10, wherein each groove in the light-spitting unit is shaped like a regular N-sided pyramid with an opening of the groove as a bottom; and the sub-pixels in the display panel are shaped like regular N-sided polygon, where: 3≦N≦8, and N is a positive integer.

12. The preparation method of a display device according to claim 10, wherein the substrate is made of a transparent material, and the grooves are formed on a surface of the substrate that is an opposite surface with respect to the display panel by forging process.

13. The preparation method of a display device according to claim 10, wherein the light-spitting unit is integrated with the display panel by fitting process, so that an opening direction of each groove is away from the display panel, and an apex of each groove orthographic projects on the display panel in a position of a central point of the sub-pixel corresponding to the groove.

14. The preparation method of a display device according to claim 10, wherein, before integrating the display panel and the light-spitting unit, the preparation method further comprises a step of forming a holographic dynamic display antireflection film on side surfaces of the grooves by coating.

15. The preparation method of a display device according to claim 14, wherein the holographic dynamic display antireflection film is made of non-memory ceramics.
